(19) United States
(12) Patent Application Publication
(10) Pub. No.: US 2022/0384777 A1
(43) Pub. Date: Dec. 1, 2022

(54) METHOD AND APPARATUS FOR ORIENTING PARTICLES IN A PASTE

(71) Applicant: BATTRION AG, Dübendorf (CH)

(72) Inventors: Max KORY, Zürich (CH); Deniz BOZYIGIT, Zürich (CH); Martin EBNER, Zürich (CH)

(73) Assignee: BATTRION AG, Dübendorf (CH)

(21) Appl. No.: 17/806,962

(22) Filed: Jun. 15, 2022

Related U.S. Application Data
(63) Continuation of application No. PCT/EP2020/085676, filed on Dec. 11, 2020.

(30) Foreign Application Priority Data
Dec. 19, 2019 (DE) 10 2019 135 308.4

(51) Int. Cl. H01M 4/1393; H01M 4/587; H01M 4/36; H01M 4/133; H01M 4/04; H01M 10/0525

(52) U.S. Cl. CPC H01M 4/1393; H01M 4/587; H01M 4/366; H01M 4/133; H01M 4/0471; H01M 10/0525; H01M 2004/027

(57) ABSTRACT

The invention relates to a method for orienting particles in a paste, comprising: providing the paste, which comprises particles that can be oriented in the paste, wherein the paste comprises, in particular, carbon-based particles, preferably graphite, and/or a volatile substance, and exposing the paste to the influence of a force field such that the particles experience a force due to the interaction with the force field, by means of which the particles are oriented relative to the field lines of the force field. For cost savings and improvement to productivity, the paste is heated in order to at least temporarily reduce the viscosity of the paste and to reduce the orientation time required for orienting the particles in the force field, wherein the paste is heated before exposing and/or while exposing the paste to the influence of the force field.

### CROSS REFERENCE TO RELATED APPLICATIONS

This application is a continuation of International Application No. PCT/EP2020/085676 filed Dec. 11, 2020, which designated the United States, and claims the benefit under 35 USC § 119(a)-(d) of German Application No. 10 2019 135 308.4 filed Dec. 19, 2019, the entireties of which are incorporated herein by reference.

### FIELD OF THE INVENTION

The present invention relates to a method and an apparatus for orienting particles in a paste and furthermore to a method for producing coating of a substrate, in particular, when manufacturing graphite-coated electrodes for lithium ion batteries.

### BACKGROUND OF THE INVENTION

In the state of the art, such methods are used in which particles are oriented in a paste, for example, when producing negative electrodes for rapid-charging lithium ion batteries. Such orientation may be caused, for example, by applying magnetic fields to the layer made from the corresponding paste applied to the substrate, as described, for example, in WO 2018/047054 A1.

### SUMMARY OF THE INVENTION

The object of the present invention is to be able to improve methods with regard to costs and productivity, in particular, production methods and coating methods which provide orientation of such particles in a paste as a method step.

The present invention achieves this object of being able to satisfy the constantly increasing requirements with regard to costs and productivity by developing such a method for orienting particles in the paste such that it may be integrated into a continuous method, such as, for example, a reel-to-reel method. In principle, the method of the present invention may be used for orienting different types of particles in a paste. The method can be applied, for example, as part of a process for producing lithium ion batteries, more precisely for producing electrodes (for the electrochemical cells used here: negative electrodes). In the lithium ion battery (or secondary storage battery), the anode comprises a graphite layer, in which lithium ions intercalate. During the discharging process, this arrangement releases electrons which flow to the cathode via the external circuit which is to be supplied by the cell. At the same time, lithium cations move from the intercalation layer through the electrolyte of the cell to the cathode. In order to be able to recharge the secondary storage battery later, the process is reversed, wherein the lithium cations have to move from the cathode back in the direction of the anode.

The layered structure of the graphite used is composed of graphite particles which are often present in lamellae form. After applying the graphite layers, in most cases parallel orientation of the graphite particles to the surface, on which they have been applied, takes place. During the movement of lithium cations through this layer, the lithium ions have to move around these lamellae, which leads to entangled pore movements and to comparatively large path lengths when the lithium ions diffuse. For this reason it has proved to be advantageous to orient the graphite particles:
Firstly, such that the lamellar particles are oriented as perpendicularly as possible to the surface of the substrate with their longitudinal axis which is present along the longer side of the lamellae.
Secondly, orientation may take place advantageously such that the lamellae are arranged or aligned in a direction perpendicular to the surface of the anode if possible one behind another.

Hence, the path lengths during movement of the lithium ions may be significantly shortened. This has an effect particularly advantageously in that the charging process may be shortened very considerably chronologically by this measure, because the ions need less time to diffuse and hence the cell also needs less time to charge.

Not least, the performance of the battery may also be significantly improved by shortening the diffusion path lengths by orienting particles, since during the discharging process, the corresponding charge carriers have to trace shorter paths and may move more quickly. Furthermore, it has been proved that the service life of the batteries is also improved in practice by this measure.

In the industrial manufacture of anodes, partly for this reason, lamellar graphite particles are also rounded off. However, this measure has the disadvantage that firstly, an additional production step is required, secondly, large quantities of graphite material are however also lost in the process.

Orientation of the particles may be carried out in that the paste with the particles located therein is exposed to a force field. Due to their anisotropy, the diamagnetic graphite particles can be oriented in a magnetic field, wherein chronologically or locally changeable magnetic fields are used.

However, in principle, the present invention may also be used for further applications in which other particles in a paste are to be oriented. For example, they may also be other particles that can be magnetically influenced, such as, for example, magnetic nanoparticles or particles, such as, for example, alumina or boron nitride, which are coupled with particles that can be magnetically influenced.

Accordingly, the method of the present invention for orienting particles in the corresponding paste comprises first of all providing the paste with the particles that can be oriented located therein. As already shown, they may be, for example, carbon-based particles, such as, for example, made of graphite. Furthermore, the paste may comprise a volatile substance. When applying the method in connection with the manufacture of anodes for lithium ion batteries, an aqueous suspension of graphite particles is mixed with CMC (carboxymethylcellulose) and then an SBR binder (styrene-butadiene rubber latex binder) is added. The CMC on the one hand as surface modifier ensures that graphite particles disperse well in water, secondly the CMC chains ensure that the resulting suspension forms the basis of a stable viscose paste which has less settling and at the same time is thin enough at high shearing rates to be able to be applied bubble-free to a surface (for example, using a slot nozzle). The SBR binder ensures that the coating applied adheres to the substrate film and the coating has sufficient elasticity. For this application, water is thus used as the volatile substance. The proportion of water may in principle evaporate out of the paste, particularly when the ambient temperature of the paste is increased.

To orient the particles in the paste, the latter is placed under the influence of a force field such that the particles experience a force due to the interaction with the force field, which may lead to orientation thereof relative to the field lines of the force field.

The method of the present invention is now characterized in that to heat the paste in order to at least temporarily reduce the viscosity of the paste and to reduce the orientation time required for orienting the particles in the force field.

Accordingly, heating of the paste takes place before or while the latter is placed under the influence of the force field. If the paste is already heated before it is exposed to the force field, this measure may have the advantage that the viscosity in the preheated paste is already reduced when the particles start to orient. The higher the viscosity, the more viscous the surroundings of the particles and the more time is required so that the particles may be oriented according to the force field. In addition to the temperature, the viscosity also depends on the solids content of the paste. This shortening of orientation time advantageously facilitates also being better able to integrate this method step of orientation of the particles within the paste in a production process. Since the substrate material coated with paste no longer has to be separated from the process in order to carry out orientation of the particles separately due to the length of this working step. Rather, the orientation step may also be integrated into a conveyer-belt method or into a reel-to-reel method. Time may be saved, productivity increased and hence, in particular, the costs may also be reduced. Furthermore, higher degrees of orientation of the particles in the paste may also be achieved, because the particles in the low-viscosity surroundings may be more easily rotated by a force field.

Moreover, heating of the paste may also be used for further technical purposes. In an advantageous example of the present invention, heating of the paste may also be used for drying the paste, which may also lead, in particular, to the particles in the paste also remaining in this position after their orientation. Heating of the paste may thus additionally also take place after exposing the paste to the influence of the force field. If the paste is dried, in principle its viscosity in turn is also increased, that is, the particles are increasingly immobilized and finally remain in the position into which they have been rotated during orientation. During heating or drying, the volatile substance usually escapes. In this context, attention should be paid as to which effect is caused in connection with heating of the paste and under which conditions this effect may be achieved. Heating per se in principle leads to the reduction of viscosity. However, if this heating is accompanied by increased loss of volatile substance in the paste, this in turn leads to the opposite effect, namely an increase in viscosity and hence also to ever greater immobilization of the particles located in the paste.

In this respect, in one example of the present invention, heating of the paste may be used additionally to reduce the volatile proportion in the paste and/or to again increase the viscosity of the paste after temporarily reducing viscosity in order to reduce, in particular, mobility of the particles in the paste. However, a rapid drying process, which follows orientation of the particles, may also contribute to the subsequent part of the production process also being able to be resumed continuously.

Furthermore, it has been proved that the orientation process according to the present invention and the subsequent immobilization described usually also provide a stable result with regard to further processing, for example, if such samples or coated substrates still have to be pressed; orientation of the particles in the paste may nevertheless be largely retained.

In one embodiment of the present invention, the drying rate of the paste may be fixed or adapted. For example a range of drying rate between 0-50 mg/(cm²×minute), in particular, between 0-30 mg/(cm²×minute), preferably between 0-16 mg/(cm²×minute) delivers practical values. The paste spread on a substrate has a large surface, which even in principle favors the emergence of volatile substance from the paste. This leads accordingly generally to the increase in viscosity. However, drying of the paste is in principle only required if the particles in the paste are already oriented. Previously, such drying would lead to particles being able to be oriented only (if at all) with more difficulty and taking more time due to the increased viscosity in the paste. For this reason it may be advantageous to adapt the drying rate accordingly. The drying rate may be reduced accordingly before or during orientation.

One possibility for adapting the drying rate to an increased ambient temperature consists in exposing the paste, for example, to increased ambient air moisture. If the vapor pressure in the surroundings is higher, less volatile substance (for example, water) emerges from the paste into the ambient air. Generally, the volatile substance may be introduced into the surroundings of the paste in increased concentration in order to avoid the latter emerging increasingly from the paste due to the higher temperature. The volatile substance may be, for example, vaporized and introduced into the surroundings of the paste, wherein the ambient air moisture may come from the paste with the volatile substance itself.

Adaption of the drying rate may thus take place, for example, due to vapor, via a nozzle, via other types of atomization etc. In principle, it is also possible to operate at the ambient pressure, since the drying rate is usually lowered also by increasing the pressure, to which the paste is exposed.

Depending on the embodiment of the present invention, the paste may be exposed before, while or after heating to a certain drying rate which is adapted accordingly. The same applies to exposing the paste to the influence of the force field: Here too, the drying rate may be adapted both before, while or after exposing the paste to the influence of the force field. The choice of measure depends substantially on how in the chronological sequence, on the one hand, orientation of the particles is triggered, on the other hand, the drying process of the paste has to integrate chronologically. Drying advantageously also does not start too late in a manufacturing method, since otherwise embedding in the continuous process would be difficult due to the delay and too late immobilization of the oriented particles, particularly in the course of resuming the production method, could lead to some of the particles in turn losing their orientation.

To adapt the drying rate, different possibilities are conceivable. At least at times, the paste may be introduced into a chamber which ensures that the ambient volume is limited in order to be able to thus adapt the drying rate more simply. If, for example, adaptation of the drying rate takes place via adaptation of ambient air moisture, the latter must be set accordingly only within the chamber. This also has the advantage that the drying rate may be adapted comparatively homogeneously in the ambient volume, and hence also with regard to the path over which the paste is transported through the chamber. As already shown, depending on the embodiment, for example, steam, may be used which is generated by heating or is introduced into the surroundings by atomization via a nozzle. In principle, the ambient air moisture may also be adapted in that a certain saturated salt solution is introduced into the chamber which ensures that after a certain time, the ambient air moisture has a certain constant value. The level of air moisture depends, in particular, on the choice of salt solution. It is also conceivable to adapt the drying rate via a pressure increase. Even this may advantageously take place in a chamber.

A suspension, in particular, an aqueous suspension, that is, a quantity of liquid and solid constituents, may be used as the paste, in particular, as starting material. The liquid constituent or some of it, for example, water, may then be the volatility constituent.

The method of the present invention or one of the examples may be used, in particular, for producing coatings of a substrate, preferably when manufacturing graphite-coated anodes for lithium ion batteries, after the paste has been applied to the coated substrate. The productivity can thus advantageously be improved and the costs lowered when a corresponding method step for orientation may be integrated into a continuous method, such as, for example, a reel-to-reel method, by the present invention.

A corresponding apparatus for orienting particles in a paste according to the present invention thus comprises at least one force source in order to expose the paste to a force field such that the particles experience a force due to the interaction with the force field, by means of which they may be oriented relative to the field lines and furthermore a heating apparatus. It may be, for example, an infrared lamp, a heater fan, heated reels which serve to transport the substrate, an inductive heat source, a microwave or even hot steam. Hot steam at the same time advantageously facilitates even the probably active medium, provided it is water, also being supplied, that is, in addition to heating, also ensures that the drying rate remains comparatively low. The heating apparatus is thus arranged with regard to the force source or can be monitored such that the paste is heated before exposing or while exposing the paste to the influence of the force field.

In an advantageous embodiment of the present invention, the force field may be a magnetic field such that, for example, magnetically anisotropic graphite particles may then be oriented. The magnetic field which is generated may be locally or chronologically changeable. For diamagnetic graphite particles, this favors orientation across a transport path. For example, in the production of anodes for lithium ion batteries, chronologically or locally changeable fields may be generated in that permanent magnets are lined up in so-called boards such that the field strength is increased with respect to an individual permanent magnet and arranged such that the field lines correspond to the required field pattern. Permanent magnets may usually be acquired relatively inexpensively. They may be put together in simple guides like bars, and by orientation or arrangement of the bars thereof, in turn a locally changing field may thus be generated. The boards are usually at least as wide as the width of the transport path such that a homogeneous field exists transversely to the transport direction across the substrate. If a sample is guided over such a locally changeable alternating field, for a certain point on the sample/the substrate during transport of the sample over the locally changed magnetic field, a chronologically changing magnetic field is produced. By using permanent magnets, costs, in particular, also power costs (differing, for example, from electrical generation of a magnetic field, for example, by a coil arrangement) may be saved.

The method of the present invention or the apparatus of the present invention favor, in particular, that the sample or the substrate is transported from one production step directly to the next, that is, embedding in a continuous manufacturing process is possible. In particular, the substrate with the paste applied thereto may be guided via reels over the force field source, over the locally changeable field such that from the point of view of the paste, a chronologically changeable field exists. This facilitates integration of the steps into a production process and facilitates saving of time.

The heating process, with which first of all the viscosity of the paste is reduced for simpler orientation of the particles, may take place via a heating apparatus. This in turn may also be arranged or monitored such that the paste also continues to be heated even after orientation of the particles in the force field in order to dry the paste. Immobilization of the particles is thus facilitated, that is, the oriented particles are prevented from losing their orientation.

Furthermore, in one development of the invention, the chamber may be configured as a moisture chamber with an air moisture source in order to generate a certain drying rate and to reduce vaporization of volatile substances from the paste, wherein the moisture chamber is arranged such that the paste is transported at least at times through the chamber by the transport apparatus.

Adaptation of the drying rate may in principle counteract the effect that the paste loses the volatile substance as a constituent due to heating. If drying of the paste is counteracted, this favors the mobility of the particles in order to be able to orient them. If drying is intensified, this favors in principle immobilization of the particles. Depending on which effect is required, adaptation of the drying rate may thus take place before, while and/or after exposing the paste to the influence of the force field or before, while and/or after heating the paste. This measure also facilitates integration in a manufacturing process and increases productivity; since the quicker the particles are oriented and subsequently immobilized, the easier the implementation in continuous manufacture.

The drying rate or parameters which influence the drying rate, such as temperature, air moisture or ambient pressure, to which the paste is exposed, may be influenced by a monitoring apparatus. Monitoring means in principle controlling and/or regulating. For this purpose, the monitoring apparatus may use different sensors, for example, corresponding temperature sensors, hygrometers, pressure-measuring apparatuses (barometers) or the like in order to be able to measure the ambient properties around the paste or even in the paste. Particularly constant regulation may thus take place such that the samples may be manufactured with consistent quality. The monitoring apparatus may also be configured to completely switch off individual apparatuses, such as air moisture sources, heating apparatuses or parts of the force field source.

The moisture chamber may optionally also be divided into different zones. Carrying out division into sub-chambers may lend itself to this, wherein, in particular, the transport apparatus guides the paste or the substrate coated with the paste through the corresponding sub-chambers one after another. It is thus also conceivable to be able to more specifically adapt orientation and drying of the paste.

For example, heating with simultaneous reduction of the drying rate, be it by pressure increase or by increasing the air moisture, may take place in the first sub-chamber. These conditions are maintained until the particles are oriented. Then, if the particles are oriented, as rapid as possible drying should take place in order to fix orientation of the particles or to immobilize the particles such that the substrate with coating or the paste may immediately be further processed, for example, pressed.

In one design variant of the present invention, the chamber or at least one of the sub-chambers may also be filled or flooded with a gas, in particular a gas other than air. The escape of a volatile substance from the paste may thus optionally be influenced, in particular, reduced. Moreover, the drying rate of the volatile component may be reduced in the chamber or at least one of the sub-chambers in that the temperature of the gas located above the paste is reduced, since in principle the lower temperature of the gas leads to a lower uptake of the volatile substance from the paste in the gas located thereabove.

### BRIEF DESCRIPTION OF THE DRAWINGS

Examples of the present invention are shown in the drawings and are illustrated in more detail below with statement of further details and advantages.

FIG. 1 is a schematic representation of an apparatus for orienting particles according to the present invention;

FIG. 2 is a further apparatus for orienting particles according to the present invention which provides adaptation of the air moisture with regulation; and

FIG. 3 is an apparatus for orienting particles according to the present invention which provides adaptation of the air moisture with regulation, a corresponding section of the manufacturing path is however divided into individual zones or sub-chambers with individual regulation.

### DETAILED DESCRIPTION OF THE INVENTION

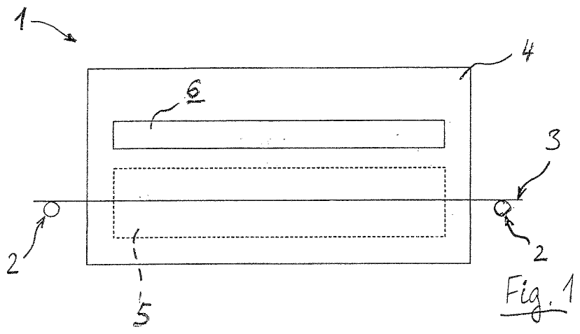

FIG. 1 shows a schematic representation of an apparatus 1 for orienting particles in a paste according to a basic structure. This apparatus 1 comprises a transport apparatus 2 for reel-to-reel transport. A substrate 3, which is coated with the paste, is transported via these reels 2. The transport apparatus 2 already shows that the method step shown here in part may be embedded in a continuous production process and the substrate to be processed is guided from processing station to processing station.

In FIG. 1, the coated substrate is introduced at times into a chamber 4 via the transport apparatus 2 so that the substrate 3 within this chamber 4 is exposed to certain ambient characteristics (for example, a certain air moisture, a certain pressure or the like). In the region of the chamber 4, the substrate 3 is exposed to a force field which is generated by means of a force field source 5 in the chamber 4 in the vicinity of the substrate 3. This force field source 5 may cause orientation of the particles in the paste. Furthermore, a heating apparatus 6 is provided which ensures that the coated substrate 3 is heated and the paste loses viscosity such that the particles located therein may be oriented more easily and more rapidly. Orientation may advantageously take place in this respect in the time in which the corresponding section of the substrate 3, which is moved continuously via the transport apparatus 2, is located in the chamber 4 in the region of the force field source 5. Chamber 4 and force field source 5 or heating apparatus 6 may have appropriate dimensions.

In the present example according to FIG. 1, the force field source 5 and the heating apparatus 6 are arranged such that, seen chronologically, precisely during orientation of the particles, heating also takes place. During transport of the substrate 3, the paste is thus exposed simultaneously to the heating apparatus 6 and also to the force field generated by the source 5.

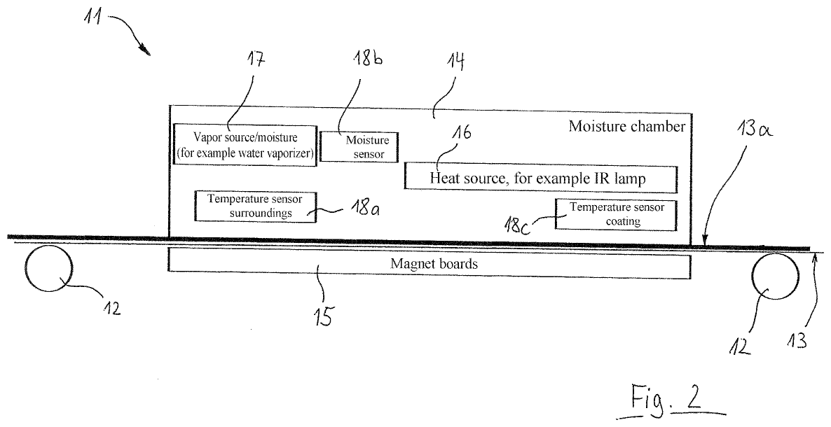

A similar example can be seen in FIG. 2. The corresponding apparatus 11 for orienting particles in a paste also comprises here a transport apparatus 12 in the form of reels, wherein a substrate film 13, which is coated with a paste 13a, is transported. The substrate 13 with the coating 13a is transported through a moisture chamber 14. As force field source 15, an arrangement of so-called magnet boards, which extend over the entire region of the moisture chamber 14 with regard to the transport path of the substrate 13, is provided below the chamber 14. These magnet boards 15 may consist, for example, of a bar-like arrangement of permanent magnets, wherein these bars are arranged in lines transversely or substantially transversely (at a predetermined angle offset, deviating from a 90° orientation) to the transport direction such that orientation of field lines changes from line to line and the coating 13a experiences a magnetic alternating field during transport through the chamber 14. Within the chamber 14, a heating apparatus 16 in the form of an IR lamp is provided first of all in the starting region thereof (in FIG. 2: from right to left). The air moisture in the chamber 14 is generated by a vapor source or a vaporizer 17. Both temperature and air moisture in the surroundings are determined via corresponding sensors 18a, 18b. Furthermore, a temperature sensor 18c is provided but which is configured and arranged such that measures only the temperature of the coating or of the paste 13a. The data of the sensors 18a, 18b, 18c are forwarded to a monitoring apparatus (not shown), which in turn regulates in particular the heating apparatus 16 and the vapor source 17.

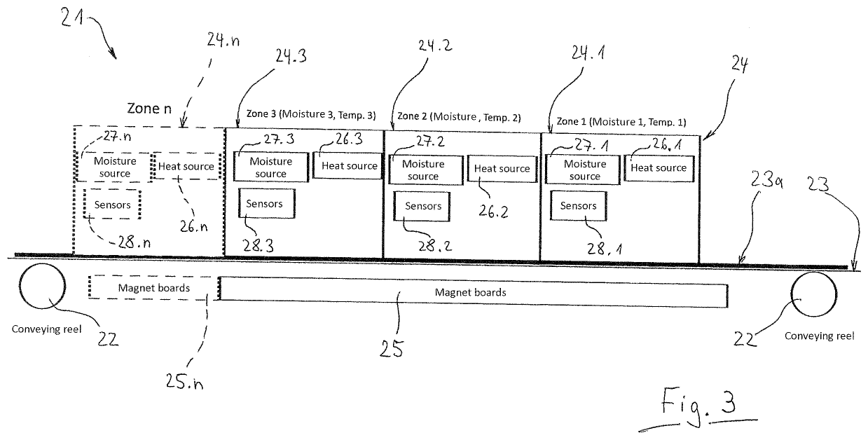

An apparatus analogous in basic structure to that in FIG. 2 is shown in FIG. 3, but the chamber 24 is divided into individual sub-chambers 24.1, 24.2, 24.3, . . . , 24.n. FIG. 3 shows an apparatus 21 for orienting particles which first of all has in any case a transport apparatus 22 in the form of reels, via which a substrate film 23 with a coating 23a is guided and transported. Analogously to FIG. 2, so-called magnet boards 25, which serve as a force field source, are arranged below the substrate tape 23. Each sub-chamber 24.1, 24.2, 24.3, . . . , 24.n has a heating apparatus 26.1, 26.2, 26.3, . . . 26.n, and furthermore corresponding vapor generators 27.1, 27.2, 27.3, . . . , 27.n to set the air moisture in the respective sub-chambers 24.1, 24.2, 24.3, . . . , 24.n. Each sub-chamber 24.1, 24.2, 24.3, . . . , 24.n is fitted individually with sensors 28.1, 28.2, 28.3, . . . , 28.n such that air moisture and temperature for each of the sub-chambers may be regulated individually via one or more monitoring apparatuses.

Depending on the embodiment, the magnet boards 25 may extend over all sub-chambers 24.1, 24.2, 24.3, . . . , 24.n along the transport path or even already end beforehand; this is shown by indicating a magnet board section 25.n drawn as a dashed line. It is conceivable, for example, to lower air moisture in the sub-chamber 24.n lying thereabove even below the normal ambient value (by means of silica gel) or to lower the pressure in order to consciously increase the drying rate here in order to rapidly immobilize the particles.

### LIST OF REFERENCE SIGNS

1 Apparatus for orienting particles in a paste
2 Transport apparatus
3 Substrate
4 Chamber
5 Force field source
6 Heating apparatus
11 Apparatus for orienting particles in a paste
12 Transport apparatus
13 Substrate
13a Paste/coating
14 Moisture chamber
15 Magnet boards
16 IR lamp
17 Vapor source
18a Temperature sensor
18b Moisture sensor
18c Temperature sensor for coating
21 Apparatus for orienting particles in a paste
22 Transport apparatus
23 Substrate
23a Paste/coating
24 Chamber
24.1 Sub-chamber
24.2 Sub-chamber
24.3 Sub-chamber
24.n Sub-chamber
25 Magnet boards
25.n Magnet boards
26.1 IR lamp
26.2 IR lamp
26.3 IR lamp
26.n IR lamp
27.1 Vapor source
27.2 Vapor source
27.3 Vapor source
27.n Vapor source
28.1 Sensor
28.2 Sensor
28.3 Sensor
28.n Sensor

1. A method for orienting particles in a paste comprising:
providing the paste, which comprises particles that can be oriented in the paste, wherein the paste comprises in particular carbon-based particles, preferably graphite, and/or a volatile substance,
exposing the paste to the influence of a force field such that the particles experience a force due to the interaction with the force field, by means of which the particles are oriented relative to the field lines of the force field,
characterized by
heating the paste in order to at least temporarily reduce the viscosity of the paste and to reduce the orientation time required for orienting the particles in the force field,
wherein heating of the paste is carried out before exposing and/or while exposing the paste to the influence of the force field.

2. The method as claimed in claim 1, wherein heating the paste is also carried out additionally after exposing the paste to the influence of the force field.

3. The method as claimed in claim 1, wherein heating the paste is used additionally:
to reduce the proportion of volatile substance in the paste, and/or
to increase the viscosity of the paste again after temporary reduction of the viscosity, and/or
to immobilize the particles.

4. The method as claimed in claim 1, wherein the paste is set to a certain drying rate which lies in a range from 0 to 50 mg/(cm²×minute), in particular from 0-30 mg/(cm²×minute), preferably from 0-16 mg/(cm²×minute).

5. The method as claimed in claim 1, wherein the paste is exposed to the certain drying rate before and/or while and/or after:
heating, and/or
exposing the paste to the influence of the force field.

6. The method as claimed in claim 1, wherein to adapt the drying rate:
the paste in a chamber is introduced at least at times into a limited ambient volume in order to be able to locally adapt the drying rate of the paste, and/or
steam is used, and/or
a saturated salt solution is introduced into the chamber, and/or
the ambient pressure is adapted, in particular increased, and/or
the paste in a chamber is introduced at least at times into a limited ambient volume and the temperature of the gas in contact with the paste in the chamber changes, in particular is reduced to reduce the drying rate, and/or
the paste in a chamber is introduced at least at times into a limited ambient volume and the chamber is flooded with a gas.

7. The method as claimed in claim 1, wherein an in particular aqueous suspension is used as the paste.

8. A method for producing coatings of a substrate, in particular when manufacturing graphite-coated anodes for lithium ion batteries, wherein a method as claimed in claim 1 is used after the paste has been applied to the substrate to be coated.

9. An apparatus for orienting particles in a paste, wherein the paste comprises particles that can be oriented therein and wherein the paste has in particular carbon-based particles, preferably graphite, and/or a volatile substance, comprising:
a force field source in order to expose the paste to a force field such that the particles experience a force due to the interaction with the force field, by means of which the particles are oriented relative to the field lines of the force field,
a heating apparatus, in particular an infrared lamp and/or a heater fan and/or a microwave generator in order to heat the paste, to at least temporarily reduce the viscosity of the paste and to reduce the orientation time required for orienting the particles in the force field,
wherein the heating apparatus is arranged with regard to the force field source and/or can be monitored such that the paste is heated before exposing and/or while exposing the paste to the influence of the force field.

10. The apparatus as claimed in claim 9, wherein the force field source, which is in particular configured to generate a magnetic field which is configured to generate a locally and/or chronologically changeable field.

11. The apparatus as claimed in claim 9, wherein a transport apparatus is provided in order to move the paste and/or the paste applied to a substrate along the force field source, in particular the force field source generating a locally changeable field such that a chronologically changeable field prevails at the paste.

12. The apparatus as claimed in claim 9, wherein the heating apparatus is arranged with regard to the force field source such that the paste is also additionally heated after exposing the paste to the influence of the force field.

13. The apparatus as claimed in claim 9, wherein a moisture chamber is provided with an air moisture source in order to generate a certain drying rate and to reduce vaporization of the volatile substances from the paste, wherein the moisture chamber is arranged such that the paste is at least at times exposed to the certain drying rate:
before and/or while and/or after exposing the paste to the influence of the force field, and/or
before and/or while and/or after heating,
wherein in particular the transport apparatus is configured to transport the paste through the moisture chamber.

14. The apparatus as claimed in claim 9, wherein a monitoring apparatus is provided to monitor the air moisture source and/or the heating apparatus in order to monitor the drying rate and/or the temperature, wherein the monitoring apparatus comprises in particular at least one sensor a temperature sensor and/or a hygrometer and/or a pressure-measuring apparatus in order to determine the temperature and/or the air moisture and/or the pressure and/or the drying rate in the moisture chamber and/or in the paste.

15. The apparatus as claimed in claim 9, wherein
the moisture chamber is divided into at least two sub-chambers in which respectively different temperatures and/or ambient air moistures and/or different pressure and/or a different drying rate can be produced by means of the monitoring apparatus,
wherein in particular the transport apparatus is configured to transport the paste through the sub-chambers one after another.

16. The apparatus as claimed in claim 9, wherein at least one chamber is provided which has in particular an apparatus for introducing gas into the chamber, which is configured to change the temperature of the gas located in the chamber and/or introduced in order to generate a certain drying rate and to reduce the uptake of volatile substances from the paste into the gas, wherein the chamber is arranged such that the paste at least at times is exposed to the certain drying rate
before and/or while and/or after exposing the paste to the influence of the force field, and/or
before and/or while and/or after heating,
wherein in particular the transport apparatus is configured to transport the paste through the chamber.
